(19) United States
(12) Patent Application Publication
(10) Pub. No.: US 2011/0137548 A1
(43) Pub. Date: Jun. 9, 2011

(54) Multi-Modal Life Organizer

(75) Inventors: Guo Bin Shen, Beijing (CN); Zheng Zhang, West Lafayette, IN (US); Kun Zheng, Beijing (CN); Xin Zou, Beijing (CN); Min Wang, Beijing (CN); Fan Yang, Beijing (CN)

(73) Assignee: Microsoft Corporation, Redmond, WA (US)

(21) Appl. No.: 12/632,575

(22) Filed: Dec. 7, 2009

(51) Int. Cl. G01C 21/00; G06F 3/048

(52) U.S. Cl. 701/201; 701/208; 701/207; 715/800

(57) ABSTRACT

A system for organizing a variety of information related to a user is disclosed. A user may input geo-tagged multi-modal information into a mobile device. This data is automatically transferred to cloud computing resources, and made available for access by the user at a desktop or laptop computing device. After input, an implicit search based on the geolocation of the input may be undertaken and results provided to the user. Input may be flags to designate a personal point of interest (PPOI), for sharing with others, for enabling location or people-based reminders, and so forth. Reminders for upcoming activities are provided to the user such that the user has sufficient time to move from the current geolocation to the geolocation of the activity.

### BACKGROUND

Daily life is complicated by a bewildering array of interactions, choices, fragments of information, and commitments. For example, when a person visits a place that she finds interesting, she might want to mark the location and share it with friends. Or, this same person may have a thought that she would like to discuss with someone else at a later time. Currently, users may enter these items into existing time-based calendars. But there are many cases that the exact time cannot be specified when scheduling an event, or where a particular time is not called for. Moreover, existing time-based calendars remind users based on a pre-determined time interval, despite the fact that it may take different amounts of time for the user to reach the location of the appointment.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Described herein is an architecture and system for implementing a life organizer that is geolocation-centric. A user may input geo-tagged multi-modal information, or notes, into mobile devices. In one implementation, acquisition of a note may be started and stopped by shaking the device. The current geolocation of the device may be associated with the note and uploaded to cloud computing resources.

After receiving the note with geolocation information, an implicit search based on the geolocation of the input may be undertaken by the cloud computing resources and results provided to the user. Input may comprise flags to designate a personal point of interest (PPOI), files for sharing with others, location or people-based reminders, and so forth. Reminders for upcoming activities may be made at intervals determined to allow sufficient time for the user to move from the current geolocation to the geolocation of the activity. The results from this implicit search as well as reminders may then be provided to the user, either via the mobile device or a stationary device such as a desktop computer. These results may include a map showing the location associated with results and reminders, and be presented using a quick zoom feature. Furthermore, a time-to-leave may be determined and presented, as well as a time-to-arrive.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 is an illustrative architecture including a cloud and usable to implement a life organization system.

FIG. 2 is an illustrative server architecture from the cloud of FIG. 1.

FIG. 3 illustrates a screen rendering of an example user interface configured to display a note and search results based on a geolocation associated with the note.

FIG. 4 illustrates an example process of acquiring a note, determining a geolocation, assigning the determined geolocation to the note, initiating a search, and providing the results to a device.

FIG. 5 is a flow diagram of an example process of acquiring and presenting a note.

### DETAILED DESCRIPTION

This disclosure describes architectures, systems and methods for implementing a multi-modal, geolocation-centric life organizer. In one example described herein, a user generates a note with a mobile device, and the note is associated with the current geolocation of the mobile device. The user may then access the note and view the note contents as well as information resulting from an automatic search including geolocation-specific information.

The discussion begins with a section entitled “Illustrated Architecture,” which describes one non-limiting architecture in which the claimed techniques may be implemented. A section entitled “Example Interface and Search Results” depicts and describes search results presented to the user. A third section entitled “Example Process of Acquiring and Presenting a Note” follows. Finally, a brief conclusion ends the discussion.

This brief introduction, including section titles and corresponding summaries, is provided for the reader's convenience and is not intended to limit the scope of the claims, nor the proceeding sections. Furthermore, the techniques described in detail below may be implemented in a number of ways and in a number of contexts. One example implementation and context is provided with reference to the following figures, as described below in more detail. However, it is to be appreciated that this following implementation and context is but one of many.

### Illustrative Architecture

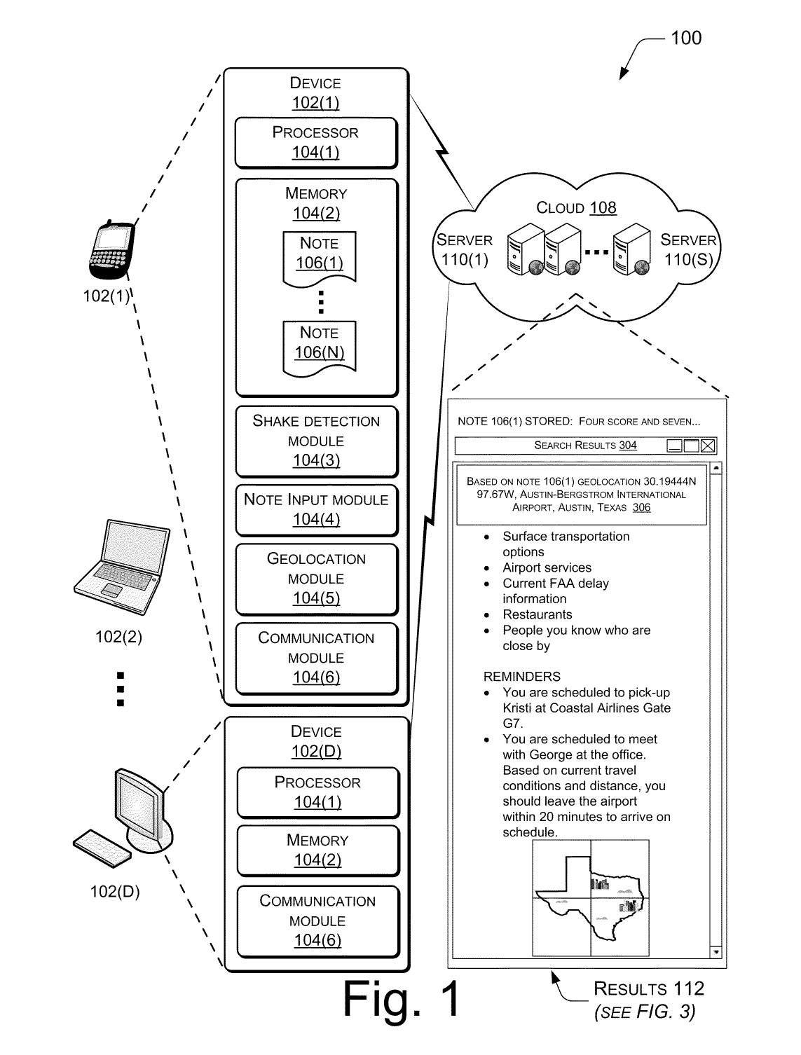

FIG. 1 illustrates an example architecture 100 in which the claimed techniques may be implemented. Here, the techniques are described in the context of devices 102(1), 102(2), . . . , 102(D). As used in this application, letters within parentheses, such as “(D)” or “(N)”, denote any integer number greater than zero. These devices may include, but are not limited to, portable computing devices such as a smartphone 102(1), laptop computers 102(2), and other devices such as a desktop computer 104(D). A portable computing device 102(1) may comprise a processor 104(1), a memory 104(2) coupled to the processor, a shake detection module 104(3), a note input module 104(4), a geolocation module 104(5), and a communication module 104(6).

Processor 104(1) may comprise one or more processors, and is configured to execute programmatic instructions. The memory 104(2) is configured to store instructions and data for use by the processor 104(1). Memory may include any computer readable storage media, including random access memory (RAM), non-volatile RAM (NVRAM), magnetic memory, optical memory, and so forth.

The shake detection module 104(3) is configured to determine relative motion of the device 102(1) and determine if the unit is being shaken. That is, the shake detection module 104(3) is configured to determine if device 102(1) is being moved briskly to and fro intentionally by the user. Shake detection module 104(3) may incorporate or access accelerometers, strain gauges, or other sensors to determine when the shaking motion occurs.

Device 102(1), meanwhile, may be configured to begin acquisition of a note in response to determining that the user has shaken the device 102(1). This acquisition may include recording audio, recording video, accepting speech for a speech-to-text speech recognition application, and so forth. Notes may also include appointment data comprising a call for action upon satisfying a particular condition or condition, such as a particular date, time, place, completion of other event, and so forth, or simply a flag indicating the user to follow up such as determine the date of the appointment at a later time. For instance, a user may be prompted to stop at a garage for an oil change when it has been six months since the last oil change, they are currently within one mile of the garage, and they have one hour unallocated for on their schedule.

In one implementation, shake detection module 104(3) may incorporate the following process to determine an intentional shake as opposed to an unintentional jostling.
a) Apply an N-point sliding window on continuous incoming accelerometer readings. N is determined by the sampling frequency of the accelerometer.
b) Establish a trend decision and local minimum/maximum point detection. For each new point, examine the new point to see if the new point obeys the trend, either increasing or decreasing. If so, then treat the new point as a shadow point. A shadow point has no impact on the trend decision, but is counted for periodicity validation. To reduce the impact of sensing noises, a safety margin is applied, i.e., those points violate the trend, but only having a small difference from their proceeding points are marked as shadow point as well.
c) For each trend, if the two ends are different enough (i.e., by a large threshold Th1), the trend is considered as an up or down transition according to whether the corresponding trend is increasing or decreasing.
d) Each pair of up and down transitions is detected as one potential shake. Any remaining singular transition may be discarded.

To increase the robustness, additional constraints may be applied. For example, in some instances a user typically shakes a device at about the same frequency. Similarly, users in general tend to shake at approximately the same frequency. Therefore, the detected potential shakes may be further validated with using periodicity checking, either for a general frequency range or for a user-defined frequency range. Thus, shakes violating a valid frequency range may be discarded. Furthermore, the shake detection module 104(3) may be “trained” by the user to recognize a deliberate shake.

In some implementations, the “shake to acquire” may be available even while device 102(1) is “locked.” For example, device 102(1) may be in a “locked” state, that is, unresponsive to keypad inputs from a user. Device 102(1) may be placed into a locked state for many reasons, including prevention of accidental access to features. However, upon shaking device 102(1), shake detection module 104(3) determines a shake is taking place, and initiates acquisition of a note. Note acquisition may be discontinued by another shake, a pre-determined threshold such as time, recording length, and so forth.

Device 102(1) may also comprise a note input module 104(4), which is configured to accept note input. Note inputs may include recording audio, accepting a text entry, taking a picture, recording a video, or a combination of these.

A geolocation module 104(5) is configured to determine the geographic location, or geolocation, of the device 102(1). Geolocation module 104(5) may access a location service from a wireless communication service, global positioning system (GPS), accept manual input, and so forth. Location may be updated continuously, at pre-determined intervals, or upon occurrence of an event, such as taking a note. Notes or appointments may include prompts for a user to specify a geolocation. For example, a user within a building may not have access to GPS signals, and thus may designate a previously acquired geolocation as being proximate to the current location. Furthermore, by localizing to proximate areas, downloads of maps to the device 102(1) may be minimized, as the currently stored map in memory 104(2) may be sufficient.

Communication module 104(6) is configured to allow device 102 to communicate with other devices, servers, communication networks, and so forth. For example, communication module may include a wireless transceiver, physical connection, and so forth.

Stored within memory 104(2) may be one or more notes 106(1), . . . , 106(N). Memory 104(2) may also store applications. An application, such as a browser or other client application, running on device 102 may facilitate access cloud resources.

Non-portable computing devices such as desktop computer 104(D) may comprise a processor 104(1), a memory 104(2), and a communication module 104(6). Other computing devices 102 may comprise at least a processor 104(1), memory 104(2), and a communication module 104(6). Non-portable computing devices such as desktop computer 104(D) and limited portability devices such as laptop 102(2) may be used to retrieve notes and supplemental information, as described later in this application.

Devices 102(1)-(D) may access a cloud 108 of network resources via communication module 104(6) connecting to a network. The network may include any one or combination of multiple different types of networks, such as cable networks, the Internet, and wireless networks.

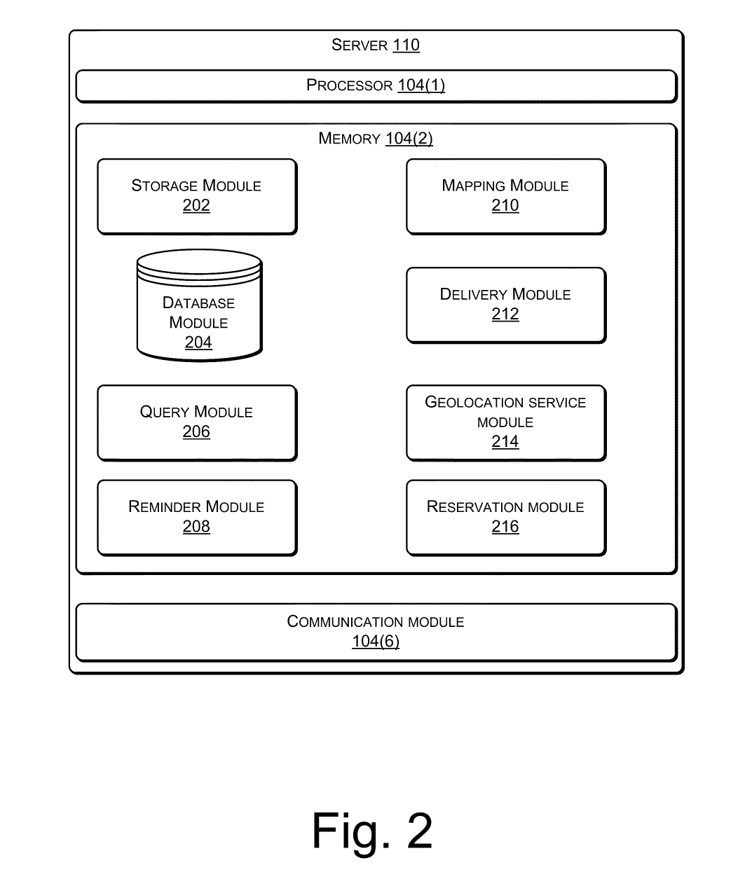

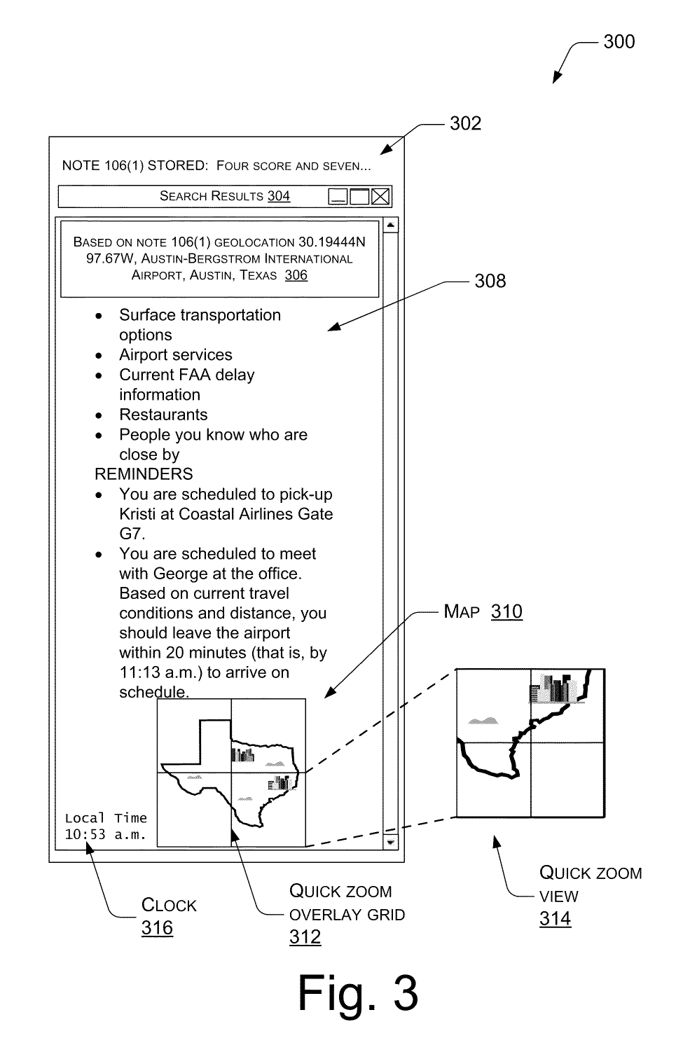

The cloud 108 of network resources may comprise one or more servers 110(1), . . . , 110(S). Servers 110(1)-(S) may accept notes 106(1)-(N) from devices 102(1)-(D), provide results 112 comprising a search based on geolocation, maps, and so forth to devices 102(1)-(D). The architecture and functions of servers 110(1)-(S) are discussed in FIG. 2, while the results 112 are discussed in more depth below with regards to FIG. 3.

FIG. 2 illustrates an example server 110(1) that may be found in cloud 108. Server 110(1) may comprise a processor 104(1), memory 104(1), and a communication module 104(6). Stored within memory 104(1) may be several modules configured to deliver the life organizer service.

A storage module 202 is configured to accept notes 106(1)-(N) and associated data and direct them for storage in database module 204. Database module 204 may be within server 110, or in some implementations may be separate from server 110 but accessible thereto.

Query module 206 is configured to take geolocation data associated with the note 106 and execute a query using the geolocation data to find information which may be of interest to the user. This query module may execute the query without prior activation by the user. For example, suppose a user enters note 106(1) which includes the words “four score and seven years ago . . . ” Geolocation module 104(5) determines a geolocation of the device at the time that the note is input to the device and associates the determined geolocation with the note 106(1). Query module 206 runs a query for data which is not only specific to the user (such personal appointments) but information which is related to the geolocation such as what restaurants are proximate to the location of note 106(1).

Reminder module 208 is configured to use the geolocation information gathered from geolocation module 104(5) to determine when reminders should be issued for appointments or other time- or event-sensitive notes. A current geolocation of device 102 may be used by reminder module 208 to update reminders. These updates may occur continuously, in response to a change in geolocation, at pre-determined intervals, upon a change in event status such as a new appointment being added, upon demand, and so forth. For example, in one implementation reminders may be dynamically updated to reflect a changing geolocation of the portable electronic device Furthermore, in some implementations, filters may be placed on reminders, thus presenting reminders for today, or for a particular city, or with a particular person, and so forth.

For example, suppose a user has a reminder for a personal appointment for lunch at a pre-determined geolocation across town. This may be a reminder which has been recently entered as a note, or which was previously stored. For routable addresses, that is addresses for which a “to and from” path in geographic space can be determined, reminder module 208 may determine that the current travel time from the current location of device 102(1) to the location of the appointment. For example, the travel time may be 47 minutes, and thus a prompt may be sent to device 102(1) indicating the travel time, and an estimated time-to-leave (TTL) as to when the user should leave in order to reach the appointment on time. Note that this differs from a conventional calendar. For example, continuing our example above, the current time is 10:53 a.m., the lunch appointment may be at 12:00 p.m., and the user receives a prompt to leave the airport within 20 minutes, that is, by 11:13 a.m. in order to arrive on time at the appointment.

A user may define transportation preferences, such as walking, bicycle, public transportation, car, airline schedules, and so forth. In another implementation, the system may provide recommendations based on optimal timing. For example, it may be faster to walk than drive to a given appointment, even when driving is preferred.

Reminder module 208 may also be configured to provide a time-to-arrive (TTA) which calculates an estimated arrival time. TTA may be adjusted to include conditions such as transportation preferences, traffic congestion, time of day, road conditions, travel delays, and so forth.

Server 110 may include a mapping module 210 configured to use the geolocation information associated with note 106 and provide relevant maps, such as that of a city or neighborhood where the note 106 was taken. Maps may be provided with an overlaid quick zoom grid, which is described in more depth below with regards to FIG. 3.

Note that in some implementations some or all of these modules may be distributed across multiple servers, be provided by an outside third party service, or a combination thereof.

Delivery module 212 is configured to provide query results, reminders, maps, and so forth to devices 102(1)-(D). Delivery may use a “push” model where content is sent to the device 102 without prior interrogation, a “pull” model where content is sent to the device 102 after an interrogation, or a combination of the two. Delivery module 212 may also format and arrange data in a manner commensurate with the type of display available on device 102. For example, delivery module 212 may reformat information to fit on the smaller screen of smartphone 102(1).

A geolocation service module 214 may also be available to server 110. Geolocation service module 214 may be configured to determine a geolocation of a device 102. Geolocation service module 214 may determine geolocation based on a network-address-to-physical-address lookup, interrogating a wireless service provider, interrogating device 102, or interrogating the user of device 102.

A reservation module 216 may also be present and configured to place reservations based on appointment data. For example, when reminder module 208 determines an appointment is located at a particular restaurant, conference room, or other location, reservation module 216 may generate reservation information for the user. Thus, a reminder to meet at restaurant “A” may include contact information or a one-click reservation option suitable for establishing a reservation for a table at the time of the appointment.

### Example Interface and Search Results

FIG. 3 illustrates a screen rendering of an example user interface 300 for the life organizer showing a note and associated search results. This user interface 300 may be displayed on device 102 after receiving the data from server 110.

At 302, contents of the note 106(1) are shown, in this example the text “four score and seven years ago . . . .” As described above, a geolocation may be assigned to a note during acquisition of the note. Query module 206 may then query one or more databases to determine information which may be relevant to the user. At 304 search results from this query are presented. Note that in some implementations, the search was initiated by the acquisition of the note, not by a specific request from the user to search.

At 306, the geolocation information which was used by query module 206 is shown. In this example, note 106(1) was taken while at Austin-Bergstrom International Airport in Austin, Tex. at a geolocation of 30.19444° North and 97.67° West. A list of detailed search results 308 associated with this geolocation is provided. This association may be topical or based on proximity between the geolocation of the note and the geolocation of the information in the database, such as the address of restaurants at the airport.

Shown in the list of detailed search results 308 are various airport specific items including links for surface transportation options, airport services, current FAA delay information, restaurants, people knows to the user who are close by, and two reminders. One reminder indicates the user is scheduled to pick-up Kristi at Coast Airlines Gate G7. Another reminder indicates that a meeting with George is scheduled at the office, and provides a TTL estimate that the user should depart the airport within 20 minutes (that is, by 11:13 a.m.) in order to make this meeting on time.

A map 310 may also be shown which is associated with the points of interest. In this example, a large scale map of the state of Texas is depicted. Map 310 may be provided to device 102 by mapping module 210 which has also provided a quick zoom overlay grid 312. The quick zoom overlay grid allows the user to quickly zoom into a map without the cumbersome process of stepping through intermediate levels. In this example, when a user selects the lower right quadrant of the quick zoom overlay grid 312, the map 310 may be changed to display quick zoom view 314 showing the selected quadrant at greater magnification. The quick zoom overlay grid 312 may be presented on successive views, although in some implementations when the greatest available magnification has been achieved it may be suppressed from the display. The quick zoom overlay grid 312 may, but need not be, arranged into a rectilinear configuration. A clock showing local time 316, in this example “10:53 a.m.” may also be presented.

### Example Process of Acquiring and Presenting a Note

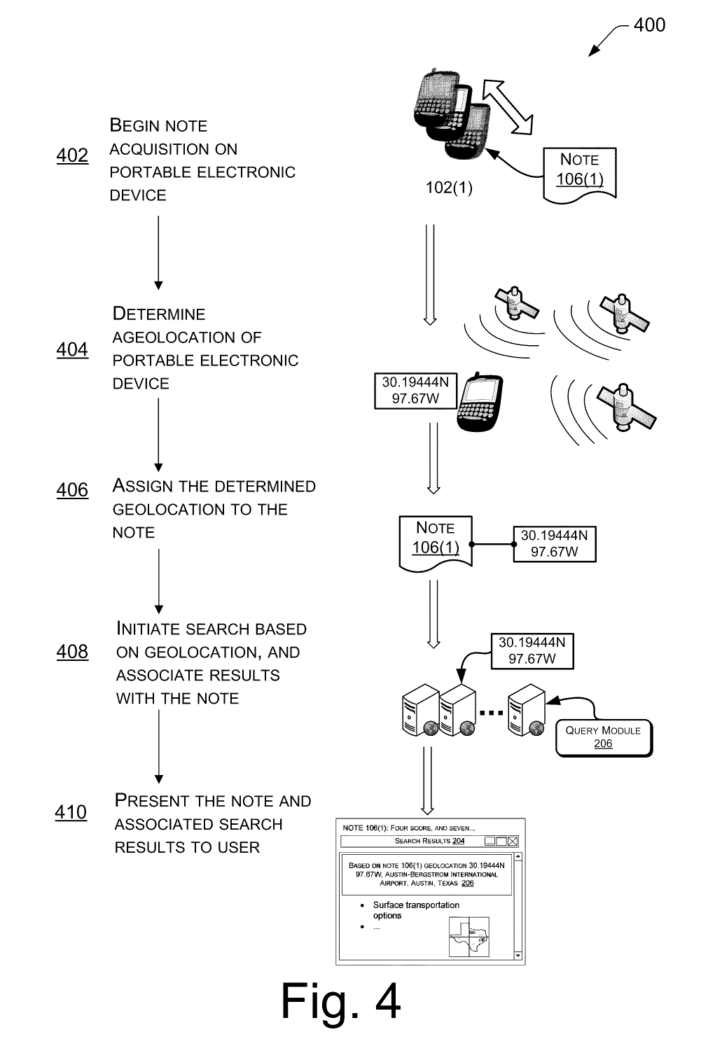

FIG. 4 illustrates an example process 400 of acquiring a note, determining a geolocation, assigning the determined geolocation to the note, initiating a search, and providing the results to a device. While FIG. 4 illustrates the described techniques in the context of a client-server, it noted that the described techniques may be equally applicable in other contexts.

Process 400 includes operation 402 in which a user begins note acquisition on a portable electronic device 102(1) by shaking the device. In other implementations, activation of a control or other input may initiate note acquisition.

Operation 404 shows the determination of geolocation of the device 102(1). In this illustration, geolocation module 104(5) in device 102(1) uses GPS signals to determine that the device is located at 30.19444° North and 97.67° West. In other implementations, geolocation may be determined by geolocation service module 214 on server 110, such as through network address lookup against a geographic database or by interrogating a wireless service provider, and so forth. In cases where device 102(1) is in a low-power mode, geolocation may be deferred to a later time. Geolocation service module 214 may also take geolocation information provided by device 102(1) and provide additional lookups, for example, determining that 30.19444° North and 97.67° West is the site of Austin-Bergstrom International Airport in Austin, Tex.

Next, operation 406 involves assigning the determined geolocation to the note. In this example, note 106(1) was taken at geolocation 30.19444° North and 97.67° West.

Operation 408, query module 206 initiates a search based on geolocation of the note and associates the results with the note. Thus, database module 204 is queried for information associated with geolocation 30.19444° North and 97.67° West. In some implementations, the query may also include information contained within the note as well. For example, if the note mentions “Rob's BBQ House” the query module 206 may search for promotional offers sponsored by “Rob's BBQ House.” Search results may also comprise reminders from reminder module 208, maps generated by mapping module 210, or a combination of these.

Finally, operation 410 presents the note and associated search results to the user. This presentation may be implemented by way of delivery module 212 which provides the search results to device 102(1) for presentation to the user.

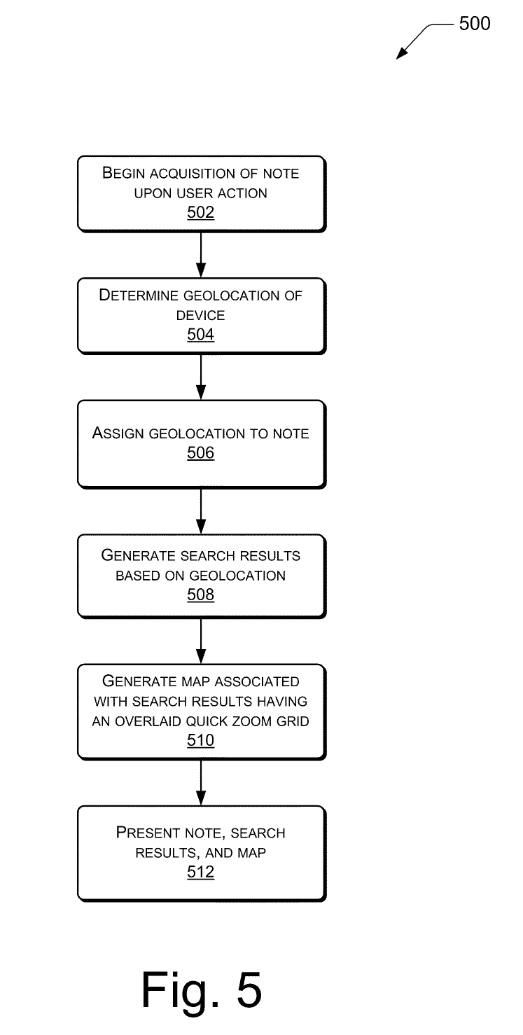

FIG. 5 is an illustrative process 500 of note acquisition and presentation that may, but need not, be implemented using the architecture shown in FIG. 1. The process 500 is illustrated as a collection of blocks in a logical flow graph, which represent a sequence of operations that can be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the process will be described in the context of the architecture of FIG. 1, but may be implemented by other architectures.

Block 502 begins acquisition of a note at a device upon a pre-determined user action. This user action may comprise a keypress, a shake of the unit, or other activating signal.

Block 504 determines geolocation of the device. Block 506 assigns the determined geolocation to the note. Block 508 initiates a search based on the determined geolocation. In some implementations the search may be initiated before acquisition of the note is concluded.

Block 510 generates a map associated with the search results which may incorporate search results, and overlays the map with a quick zoom grid. Block 512 presents the note, search results, and map on the device.

### CONCLUSION

Although specific details of illustrative methods are described with regard to the figures and other flow diagrams presented herein, it should be understood that certain acts shown in the figures need not be performed in the order described, and may be modified, and/or may be omitted entirely, depending on the circumstances. As described in this application, modules and engines may be implemented using software, hardware, firmware, or a combination of these. Moreover, the acts and methods described may be implemented by a computer, processor or other computing device based on instructions stored on memory, the memory comprising one or more computer-readable storage media (CRSM).

The CRSM may be any available physical media accessible by a computing device to implement the instructions stored thereon. CRSM may include, but is not limited to, random access memory (RAM), read-only memory (ROM), electrically erasable programmable read-only memory (EEPROM), flash memory or other solid-state memory technology, compact disk read-only memory (CD-ROM), digital versatile disks (DVD) or other optical disk storage, magnetic cassettes, magnetic tape, magnetic disk storage or other magnetic storage devices, or any other medium which can be used to store the desired information and which can be accessed by a computing device.

What is claimed is:

1. A computer-implemented method comprising:
under control of one or more computer systems configured with executable instructions,
detecting a shaking of portable electronic device;
beginning acquisition of a note upon the detecting of the shaking of the portable electronic device;
determining a geolocation of the portable electronic device when the note is acquired;
assigning the geolocation to the note;
initiating a search based at least in part on the geolocation and generating search results from the initiated search;
generating a map corresponding to at least a portion of the search results;
presenting the note, the search results, and the map on the portable electronic device; and
generating a reminder from the note.

2. The method of claim 1, wherein the shaking of the portable electronic device awakens the portable electronic device from a standby mode.

3. The method of claim 1, wherein the determining of the geolocation comprises:
interrogating the portable electronic device;
interrogating a user via the portable electronic device;
accessing a location service from a wireless communication service; or
accessing a geolocation service.

4. The method of claim 1, wherein the note comprises:
an audio recording;
a text entry;
a picture; or
a video.

5. The method of claim 1, wherein the portable electronic device is in a locked state prior to shaking and wherein the portable electronic device acquires the note while remaining in the locked state.

6. The method of claim 5, wherein the locked state renders the portable electronic device unresponsive to keypad inputs from a user.

7. The method of claim 1, wherein the geolocation is assigned to the note after geolocation information becomes available from a geolocation module.

8. A cloud computing system coupled to a communication system and comprising:
a storage module configured to communicate with a handheld computing device via the communication system and store a note comprising geolocation data;
a query module configured to execute a query using the geolocation data from the note and generate search results based at least in part on the execution of the query;
a reminder module configured to generate a time-to-arrive, a time-to-leave or both when the note comprises an appointment;
a mapping module configured to generate a map associated with at least one of the search results or appointments and overlaid with a quick zoom grid; and
a delivery module configured to deliver the note, the search results, and the map to a computing device via the communication system.

9. The system of claim 8, wherein the search results further comprise reservation information corresponding to a geolocation of an appointment.

10. The system of claim 8, wherein the note comprises:
an audio recording;
a text entry;
a picture; or
a video.

11. The system of claim 8, wherein the quick zoom grid is configured to accept a user selection of a rectilinear region of the quick zoom grid and enlarge the selected rectilinear region to a pre-determined magnification.

12. The system of claim 8, wherein the time-to-arrive or time-to-leave are based at least in part on a geolocation of an appointment and a current geolocation of the handheld computing device.

13. One or more computer-readable storage media storing instructions that, when executed by a processor cause the processor to perform acts comprising:
acquiring a note on a portable electronic device;
determining a geolocation of the portable electronic device associated with acquisition of the note;
assigning the geolocation to the note;
initiating a search based at least in part on the geolocation; and
presenting search results from the search.

14. The computer-readable storage media of claim 13, wherein the acquisition of the note commences upon a first shaking of the portable electronic device and terminates upon; (1) a second shaking of the portable electronic device; (2) meeting or exceeding a pre-determined time subsequent to the first shaking, or (3) reaching a pre-determined storage threshold of the portable electronic device.

15. The computer-readable storage media of claim 13, wherein the portable electronic device is in a locked state prior to shaking and wherein the portable electronic device acquires the note while remaining in the locked state.

16. The computer-readable storage media of claim 15, wherein the locked state renders the portable electronic device unresponsive to inputs other than shaking.

17. The method of claim 1, wherein the geolocation is assigned to the note after geolocation information becomes available.

18. The computer-readable storage media of claim 13, wherein the search results comprises a map with a quick zoom overlay, and wherein the quick zoom overlay defines user-selectable regions on the map which, when selected, enlarges the selected region to a pre-determined magnification.

19. The computer-readable storage media of claim 13, wherein the note comprises:
an appointment;
an audio recording;
a text entry;
a picture; or
a video.

20. The computer-readable storage media of claim 13, wherein the appointment further comprises a time-to-arrive, time-to-leave or both that is dynamically updated to reflect a changing geolocation of the portable electronic device.
